(19) United States
(12) Patent Application Publication
(10) Pub. No.: US 2025/0356169 A1
(43) Pub. Date: Nov. 20, 2025

(54) Measuring The Efficacy Of Large Language Models On Classification Tasks

(71) Applicant: Oracle International Corporation, Redwood Shores, CA (US)

(72) Inventor: Karempudi V. Ramarao, San Ramon, CA (US)

(73) Assignee: Oracle International Corporation, Redwood Shores, CA (US)

(21) Appl. No.: 18/664,125

(22) Filed: May 14, 2024

(51) Int. Cl. G06N 3/0475; G06N 3/0895

(52) U.S. Cl. CPC G06N 3/0475; G06N 3/0895

(57) ABSTRACT

Techniques for evaluating the efficacy of large language models on classification tasks are disclosed. A prompt that includes an instruction and a content item to be classified is submitted multiple times to a large language model. For each submission of the prompt, a corresponding classification label from a set of two or more classification labels is returned. Each classification label is compared to the expected classification label for the content item using a label distance value metric. Using the label distance value metric, a confidence score is generated.

### TECHNICAL FIELD

The present disclosure relates to generative Artificial Intelligence (AI) models. In particular, the present disclosure relates to testing the effectiveness of generative models and prompts for performance of classification tasks.

### BACKGROUND

Categorization problems present a range of complexities due to the inherent variability and subtlety of human language. For example, classifying product reviews into positive or negative categories involves parsing and understanding nuances that may not be explicitly stated, resulting in a challenging task. Statistical models and other machine learning models have been employed to address this problem by analyzing the frequency and distribution of words and phrases within a body of text to infer the sentiment it conveys.

Statistical models, for example, operate on the principle that certain linguistic features are indicative of the sentiment behind a piece of text. By training on datasets where the sentiment is known, these models learn to associate specific patterns of words and phrases with positive or negative sentiments. This training involves mathematical techniques that calculate the probability of a text belonging to a particular category based on the statistical properties of the text features observed in the training data.

However, the effectiveness of these models can be influenced by various factors, including the quality of the training data, the choice of features included in the model, and the model's ability to generalize from the training data to new instances. The context, sarcasm, and implicit meanings present in natural language can further complicate the classification task, requiring sophisticated approaches and sometimes integration with more advanced machine learning techniques, such as deep learning, to improve classification accuracy.

Generative models, such as large language models based on transformer architectures, can be applied to classification tasks. These tasks may include sentiment analysis, topic categorization, and more. Generative models leverage vast amounts of text data to learn complex patterns and dependencies in language, enabling them to understand and generate human-like text. However, their output may exhibit variability due to the probabilistic nature of language generation and the influence of their training data. This variability can manifest as inconsistency in classification results, especially when the input text contains ambiguous sentiment, uses nuanced language, or discusses topics that were underrepresented in the model's training corpus. Despite these challenges, machine learning models have proven to be powerful tools for sentiment analysis.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a machine learning engine in accordance with one or more embodiments;

FIG. 2 illustrates the operation of a machine learning engine in one or more embodiments;

FIG. 3 illustrates a system in accordance with one or more embodiments;

FIG. 4 illustrates an example set of operations for selecting an instruction for use with a generative model in accordance with one or more embodiments;

FIG. 5 illustrates an example set of operations for selecting a generative model to use for classification tasks in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. LARGE LANGUAGE MODELS
4. EVALUATION ARCHITECTURE
5. PROMPT AND MODEL EVALUATION FOR CLASSIFICATION TASKS
6. EXAMPLE EMBODIMENT
7. COMPUTER NETWORKS AND CLOUD NETWORKS
8. HARDWARE OVERVIEW
9. MISCELLANEOUS; EXTENSIONS

### 1. GENERAL OVERVIEW

Generative models inherently operate on principles of randomness. As a result, generative models often provide varied output in response to multiple instances of the same input prompt. In an example, a prompt for a generative model may include an instruction and a content item (or identifier thereof) upon which the instruction is to be applied. The generative model may output different classifications for multiple submissions of the same prompt. An evaluation of the performance of the generative model may vary based on the output that is selected for the evaluation process.

One or more embodiments determine the efficacy of a generative model by evaluating the different outputs that are generated by submitting the same prompt. Initially, the system selects a prompt as input for the generative model. The system inputs the same prompt multiple times to the generative model to generate multiple respectively outputs. Thereafter, the system compares each of the outputs of the generative model to an expected output to determine a respective distance value corresponding respectively to each output. The system computes an evaluation of the generative model based on the distance values (e.g., the mean, median, or mode of the distance values). Additionally, or alternatively, the system may compute an evaluation of the instruction that was included in the prompt based on the distance values. The evaluation of the generative model, and/or the instruction portion of the prompt may include a confidence score.

One or more embodiments described in this Specification and/or recited in the claims may not be included in this General Overview section.

### 2. MACHINE LEARNING ARCHITECTURE

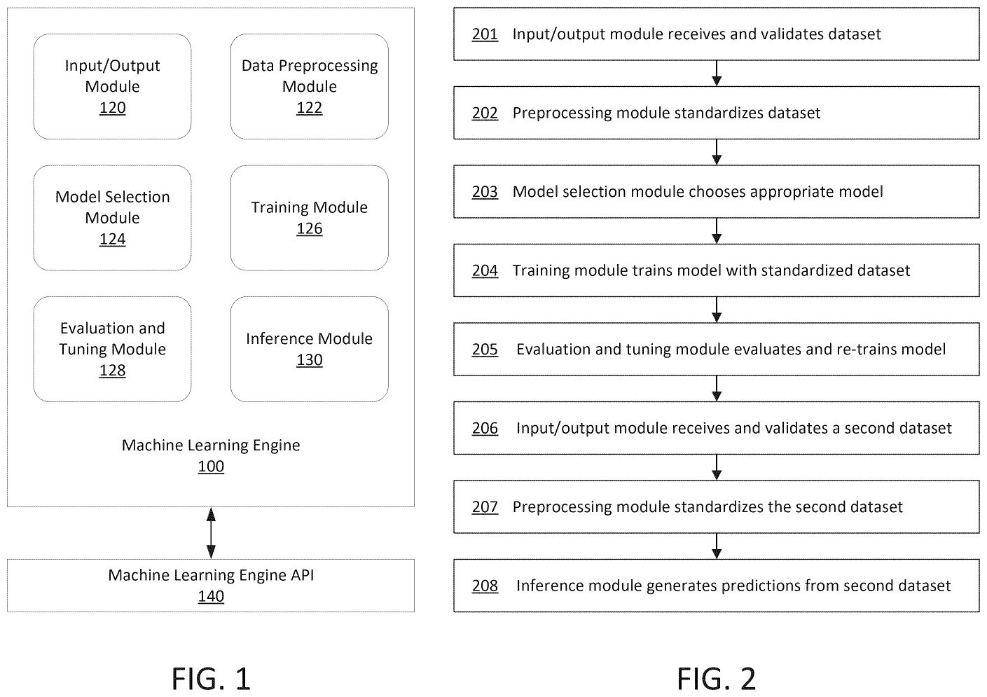

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. At step 1, input/output module 120 receives a dataset intended for training. This data can originate from diverse sources, like databases or real-time data streams, and in varied formats, such as CSV, JSON, or XML. Input/output module 120 assesses and validates the data, ensuring its integrity by checking for consistency, data ranges, and types.

At step 2, training data is passed to data preprocessing module 122. Here, the data undergoes a series of transformations to standardize and clean it, making it suitable for training ML models. This involves normalizing numerical data, encoding categorical variables, and handling missing values through techniques like imputation.

At step 3, prepared data from the data preprocessing module 122 is then fed into model selection module 124. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

At step 4, training module 126 trains the selected model with the prepared dataset. It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

At step 5, evaluation and tuning module 128 evaluates the trained model's performance using the validation dataset. Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

At step 6, input/output module 120 receives a dataset intended for inference. Input/output module 120 assesses and validates the data.

At step 7, data preprocessing module 122 receives the validated dataset intended for inference. Data preprocessing module 122 ensures that the data format used in training is replicated for the new inference data, maintaining consistency and accuracy for the model's predictions.

At step 8, inference module 130 processes the new data set intended for inference, using the trained and tuned model. It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. GENERATIVE MODELS

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

In accordance with one or more embodiments, other types of models besides large language models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 4. EVALUATION ARCHITECTURE

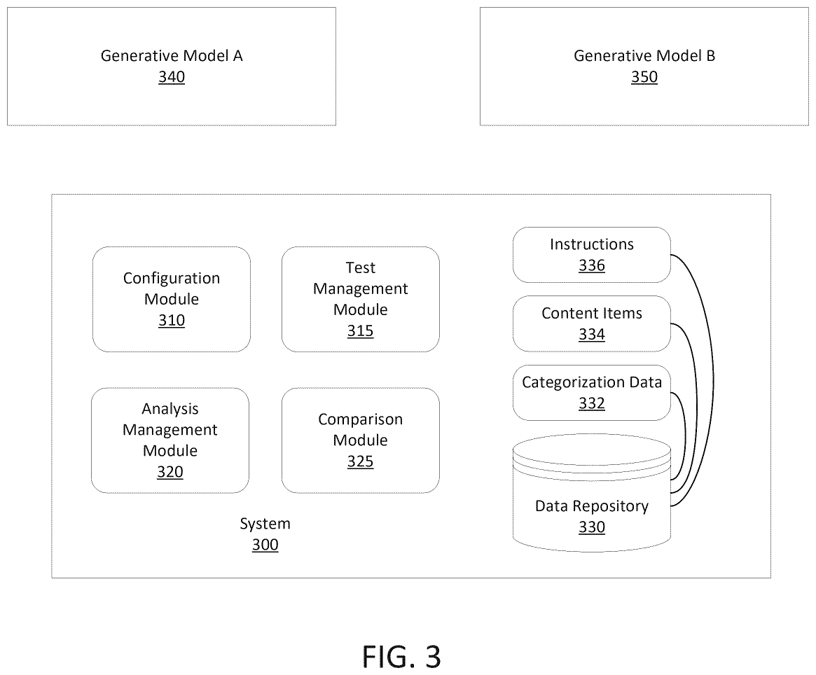

FIG. 3 illustrates a system 300 in accordance with one or more embodiments. As illustrated in FIG. 3, system 300 includes a configuration module 310, a test management module 315, an analysis management module 320, and a comparison module 325. Data repository 330 includes categorization data 332, content items 334, and instructions 336.

In accordance with one or more embodiments, configuration module 310 is responsible for managing the configuration of system 300. Configuration data that includes parameters and settings used to determine the operational behavior of the system may be stored in a variety of storage mechanisms. For example, configuration data may be stored in data repository 330 or in in-memory caches, dedicated configuration files, or external databases. The choice of storage medium may change with the need for persistence across restarts, accessibility by multiple components, and the sensitivity of the data. Configuration files that may be stored on a file system or other storage device provide a durable means of retaining settings, facilitating updates and version control.

Access to the configuration data by various system modules may be accomplished via an interface, decoupling configuration module 310 and the rest of the system. The interface may expose methods to retrieve configuration values, listen for changes, and update settings, thereby accommodating dynamic reconfiguration. Modules query the configuration module 310 by specifying keys or paths that identify the desired setting. The configuration management module may also support hierarchical configurations, allowing settings to be scoped at various levels (e.g., global, per-module, or per-instance), and fallback mechanisms, where queries for a specific setting fall back to a less specific scope or default setting if the setting is not found.

In accordance with one or more embodiments, test management module 315 is configured to manage testing activities, incorporating logic to orchestrate the execution of tests based on predefined criteria and dependencies. Test management module 315 manages the testing of instructions and generative models in an embodiment. In another embodiment, instructions and generative models may be tested using separate testing modules. Test management module 315 leverages a dependency resolution engine to ensure that tests are executed in an order that respects the causal relationships between different test cases, thereby preventing the execution of a test that depends on the outcome of another yet-to-be-executed test. Test management module 315 uses a combination of directed acyclic graphs and priority queues to manage this sequencing, allowing for both parallel and serial execution of tests as dictated by the dependency graph and available system resources.

In accordance with one or more embodiments, test management module 315 incorporates statistical models to determine the optimal number of test iterations required to achieve statistical significance for the results and/or to achieve a pre-defined confidence threshold. For example, test management module 315 may employ Welch's T-test to determine a confidence value. In accordance with one or more embodiments, test management module 315 employs adaptive testing strategies, such as sequential testing procedures, to minimize resource consumption while maximizing the likelihood of detecting significant effects, if present. Test management module 315 also supports post-hoc analysis, enabling the calculation of confidence intervals and effect sizes for test results.

In accordance with one or more embodiments, data repository 330 is any type of storage unit and/or device (e.g., a file system, database, collection of tables, or any other storage mechanism) for storing data. Further, a data repository 330 may include multiple different storage units and/or devices. The multiple different storage units and/or devices may or may not be of the same type or located at the same physical site. Further, a data repository 330 may be implemented or executed on the same computing system as system 300. Additionally, or alternatively, a data repository 330 may be implemented or executed on a computing system separate from system 300. The data repository 330 may be communicatively coupled to system 300 via a direct connection or via a network.

In accordance with one or more embodiments, data repository 330 stores data, information, and objects related to the operation of system 300. For example, instructions 336 are stored in data repository 330 in an embodiment. Instructions are templates for input into generative models. For example, an instruction may include text such as “The following is a review for the premium widget product; categorize this review as positive, negative, or neutral.” In this example, the instruction does not include the item to be categorized, referred to herein as a content item. Although any submission to a generative model, such as a large language model, could be considered a prompt, an instruction is a portion of a prompt that may be combined with content items, such as other data or text, to create a complete prompt. An advantage of using instructions is that using the same instruction with different content items may result in a more consistent outcome or output from the generative model.

In accordance with one or more embodiments, data repository 330 stores content items 334. Content items may be any data, text, object, or other information that serves as the subject of a prompt. For example, given the example instruction above, a content item to be categorized would be a review for a premium widget, or more specifically, the text of that review. As an example, the text of the review could be “The Premium Widget delivers on basic promises, offering a moderate boost in productivity, though it lacks the advanced features expected from its price point.” This review could be stored in an object. In addition, the review could include associated metadata, such as a star-rating or title. In an embodiment, content items may be any type of content item or media, such as text, an image, or a sound. Content items can also be other types of items that may be categorized other than review items. For example, art, books, scientific journals, games, recipes, podcasts, news articles, movies, video, and references to objects, such as real estate or food items, lend themselves to categorization.

In accordance with one or more embodiments, analysis management module 320 is configured to manage the analysis of test results. As test management module 315 generates test results, analysis management module 320 compares the results with expected results to determine the efficacy of the elements being tested. For example, test management module 315 may receive, as input, instructions, content items, and/or references to one or more generative models. Using an instruction and a content item to be categorized, test management module may generate a prompt to be submitted to a generative model. The output of the test may be a label (e.g., an identifier representing a category or class that a specific content item belongs to) that may be stored in categorization data 332.

In accordance with one or more embodiments, analysis management module 320 is configured to evaluate the performance of certain elements associated with a test. For example, analysis management module 320 may evaluate the performance of instructions by calculating, based on test results, how often the label assigned to a content item is correct. Similarly, analysis management module 320 may evaluate the performance of one or more generative models. A performance evaluation for a content item or a generative model may be stored in the form of a performance metric in data repository 330 in an embodiment.

In accordance with one or more embodiments, comparison management module 325 includes instruction comparison logic configured to compare two or more instructions to determine the instruction that should be used for tasks such as categorization efforts. The instruction comparison logic collects metadata associated with the runs in a test, including resource utilization, configured preferences, and performance metrics. As an example, two separate instructions A and B may be associated with a similar resource utilization, but instruction A may be more accurate. The comparison module may determine from a configuration setting that instruction B is the preferred instruction unless the difference between the performance metrics of instructions A and B differ by more than a predefined threshold amount. Otherwise, instruction A may be chosen due to the increased accuracy associated with that instruction.

In accordance with one or more embodiments, comparison management module 325 includes model comparison logic configured to compare two or more generative models to determine the model that should be used for tasks such as categorization efforts. In an embodiment, the model comparison logic collects metadata associated with the runs in a test, including resource utilization, configured preferences, and performance metrics. As an example, two separate generative models, such as generative model A 340 and generative model B 350, may be associated with different performance metrics, with generative model A 340 significantly outperforming generative model B 350. However, generative model A 340 may require more resources than generative model B 350, resulting in a dramatic cost difference. The comparison module is configured to determine the model to use based on the system's configuration. For example, if generative model B 350 meets a minimum accuracy threshold based on the performance metric, then more weight may be given to cost savings associated with resource utilization.

In one or more embodiments, the system 300 may include more or fewer components than the components illustrated in FIG. 1. The components illustrated in FIG. 1 may be local to or remote from each other. The components illustrated in FIG. 1 may be implemented in software and/or hardware. Components may be distributed over multiple applications and/or machines. Multiple components may be combined into one application and/or machine. Operations described with respect to one component may instead be performed by another component. Additional embodiments and/or examples relating to computer networks are described below in Section 7, titled “Computer Networks and Cloud Networks.”

In an embodiment, system 300 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. PROMPT AND MODEL EVALUATION FOR CLASSIFICATION TASKS

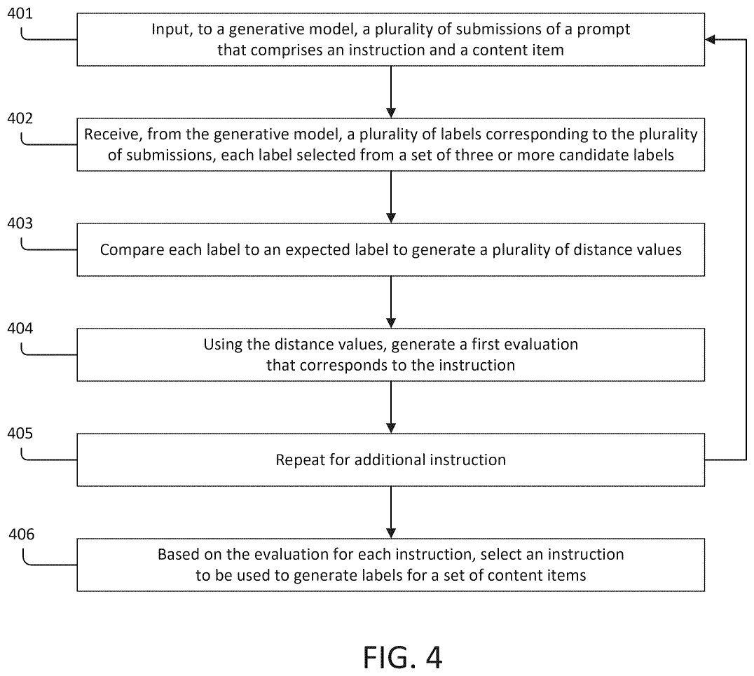

FIG. 4 illustrates an example set of operations for selecting an instruction for use with a generative model in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, system 300 inputs a plurality of submissions of a prompt to a generative model (Operation 401). The prompt is comprised of an instruction and a content item. Concatenating the previous example of a prompt and an instruction, the resulting prompt to be submitted to the generative model would be: The following is a review for the premium widget product; categorize this review as positive, negative, or neutral. The Premium Widget delivers on basic promises, offering a moderate boost in productivity, though it lacks the advanced features expected from its price point.

In the example prompt above, the instruction portion includes explicit commands to categorize the content item (e.g., the review) as positive, negative, or neutral. In accordance with one or more embodiments, the instruction and the instructions may be separated and stored separately. For example, the instruction may be “The following is a review for the premium widget product” and the commands may be “categorize this review as positive, negative, or neutral.” By separating the commands from the instruction, the system may perform a separate analysis on commands and instructions. For example, a set of commands may be selected for use in classification tasks by using the process for selecting an instruction to use for classification tasks that are described in this section. The set of potential labels (responses) may also be separated from the prompt and commands in an embodiment. In an embodiment, combinations of instructions, potential labels, and commands may be tested to select a combination to use to perform classification tasks.

In accordance with one or more embodiments, the instruction may be the commands to perform a classification task with little else. For example, the instruction may be “Categorize this review as positive, negative, or neutral.” Using the example, the full prompt would be the concatenation (or other combining method) of the instruction and the content item and results in the following prompt: “Categorize this review as positive, negative, or neutral. The Premium Widget delivers on basic promises, offering a moderate boost in productivity, though it lacks the advanced features expected from its price point.”

In accordance with one or more embodiments, commands to perform a classification task may be implicit. For example, a model, such as generative model A 340, may be configured to classify content items received and return one of a preconfigured set of labels. In this case, any content item submitted to the model will automatically return a label that classifies the content item into one of the preconfigured sets of labels available.

In another embodiment, the instruction and/or commands may be implied by context. In such cases, the submitted prompt is a combination of the implied prompt (and/or commands) and the content item. This may occur, for example, when using a large language model that is capable of maintaining context within a session. A user or device may submit a prompt to a large language model or other generative model that includes a first content item and then receive a label as output. When subsequent content items are submitted without additional text, the context implies that the subsequent content item is to be categorized in the same way, using the instruction implied by context. For example, the initial submission may be a prompt that includes the following text: “Categorize the following into a fruit, vegetable, carbohydrate, or protein. Tomato.” In this case, the content item is the word “tomato,” and the preceding text is the instruction. A label is returned, likely selected from the proposed list. For example, the large language model may return the label “fruit” in response to the prompt. The next submission may not explicitly include the instruction. For example, the next submission may be limited to consisting of the content item “Potato.” Based on the context, the constructive submission is “Categorize the following into a fruit, vegetable, carbohydrate, or protein. Potato.” Subsequent submissions of content items would benefit from the context in the same way. As discussed herein, a “submission” may include constructive submissions.

In accordance with an embodiment, a constructive submission may also include submissions that rely on an explicit command to indicate that an action should be taken by the generative model. For example, a “/classify-foodType” command may indicate that a known instruction or command should be used to classify the content item that follows the command using pre-defined labels. Thus, the command “/classify-foodType” may result in the receipt of the label “carbohydrate.” In an embodiment, commands may be simple, consisting of a single character or no character, if the generative model is configured with a default instruction or functional equivalent.

In accordance with one or more embodiments, additional commands may be included in the instruction or other portions of the prompt by system 300. For example, the prompt may include commands that indicate a requested output format. The commands may also include a request to convert responses to numerical values in an embodiment. For example, the numerical values may correspond to an ordering of the potential responses that may be used later in the process for computing label distance values.

In accordance with one or more embodiments, due to the probabilistic nature of language generation and the influence of training data, generative models may generate different answers for the same prompt. For example, when asked to classify a potato, the model may respond with either carbohydrate or vegetable. This is not the case for statistical models. Whenever a statistical model is presented with the same input, it will produce the same output. Since there is no guarantee that a generative model will produce the same output when given the same input, multiple “runs” of the prompt should be performed and the responses compared to an expected response. The same prompt will include the same instruction as well as content item and is submitted multiple times in an embodiment.

In accordance with one or more embodiments, system 300 receives labels corresponding to the submissions (Operation 402). For example, system 300 may submit a test prompt to a large language model, such as generative model A 340, that includes an instruction, a content item, and an explicit or implicit request to perform a classification task. System 300 then submits the same test prompt additional times. For each submission of the test prompt to the large language model, system 300 receives a corresponding label that classifies the content item.

In accordance with one or more embodiments, each label received is one of three or more candidate labels and stored in categorization data 332 in data repository 330. The choice presented to the generative model is not a binary choice with the expectation that the generative model choose between two possible categories or labels. Instead, three or more labels are available for selection. Although the methods described herein may be used for binary selection processes, allowing for selection from a larger set of candidate labels (e.g., 3 or more) solves a more complex problem. In binary classification, a naive model that always predicts the most common class achieves at least 50% accuracy if the classes are balanced. In multi-category classification with N classes, the baseline performance of a naive model drops to 1/N, making it inherently a more difficult task as N increases.

In accordance with one or more embodiments, system 300 compares each label received with an expected label to generate a set of corresponding distance values (Operation 403). The set of potential label values may be an ordered set of labeled values. Each label value v in a set of values V is mapped to a numerical or quantitative value and may be placed in an ordered set. For example, the label values for an application may be given by the set V={v1<v2<3< . . . <vn} for n potential label values in the set. A practical consequence of ordering the label values is that ‘correctness’ of predictions (e.g., label output) does not have to be binary and can be quantified in fractions if necessary. A ‘label-distance function’ f: V×V→[0, 1] takes each pair of label values as input and maps them to a value between 0 and 1, inclusive of both. To avoid counterintuitive behaviors, we require that f(v, v)=0 for all v in V, and it is commutative, i.e., f(u, v)=f(v, u) for u, v in V.

To illustrate the concept of a label distance with a simple example, let V={v1<v2<v3}. Any value in this set can then be thought of as being at most 2 units different from the others. For instance, v1 and v2 are separated by 1 unit, v1 and v3 are separated by 2 units, and v2 and v3 are separated by 1 unit. By taking a unit as 0.5, this function satisfies the requirements of a label-distance function. Intuitively, since there is a total ordering among the label values, it is possible to quantify an incorrect prediction by a classifier as being partially incorrect. It is also possible to quantify by how much the prediction was incorrect.

To further illustrate the concept of label distance, let V={v1<v2<v3 . . . <v11}. In this example, each value is separated by 0.1, with v1 set to 0 and v11 set to 1. If the correct value is v6, but a predicted value is v3, then the predicted value is 3 units from the correct value. If a second predicted value is v5, then the second predicted value is two units from the correct value. The number of units from the correct value represents the label distance. The label distance is a measurement of correctness that allows for the system to determine the prediction that is more correct (e.g., closer to the correct value) than the other even if neither is absolutely correct.

In accordance with one or more embodiments, a label-distance function over a given set of ordered label values can be defined in many ways, and the distances do not have to be uniform as shown in the examples above. For example, if V={v1<v2<v3<v4<v5<v6}, there are no constraints that require the unit distance between v1 and v2 to be one unit. In some cases, it may be appropriate to separate some values by more than one unit to account for inherent differences in the content items (or what they represent) being classified. For example, v1 may be set to 0, with v2 set to 0.2, and v3 set to 0.3. This indicates a greater label distance between v1 and v2 than the label distance between v2 and v3, showing that label distances need not be uniform in an embodiment.

In accordance with one or more embodiments, the system uses the distance values to generate an evaluation that corresponds to the instruction (Operation 404). A generative model may run k times on each test content item with a given instruction. This results in m*k predictions for the instruction. A label-similarity function g based on these predictions may be used to generate a correctness score. For each prediction u and the corresponding correct label value v, the system can compute the correctness score as g(u, v). The system can then compute the mean of the m*k scores to generate an accuracy score.

The following example illustrates a calculation of an accuracy score in accordance with one or more embodiments. An instruction may be: “How well do the skills ‘reinforcement learning, deep learning’ match with the job {job}? Answer only with one of ‘quite well’, ‘little’, or ‘somewhat’. The content item may be: “Job: AI market analyst”. The model being used is an LLM, so the responses over 15 runs of the prompt that includes both the instruction and the content item may return inconsistent values, such as the following values: quite well, somewhat, somewhat, somewhat, somewhat, somewhat, quite well, somewhat, somewhat, somewhat, somewhat, somewhat, somewhat, very little, and somewhat. Given a language similarity function g(‘quite well’, ‘little’)=0, g(‘quite well’, ‘somewhat’)=0.3, g(‘little’, or ‘somewhat’)=0.1 and that the correct label is ‘somewhat’, the mean correctness score can be computed as (0.3+1+1+1+1+1+0.3+1+1+1+1+1+1+0+1)/15=12.6/15=0.84. In contrast, a traditional accuracy score based on a binary correct/incorrect determination would be 12/15=0.8.

In accordance with one or more embodiments, a threshold may be applied to the label-distance function to define the counterparts of false positives and false negatives. For a threshold value t, a false-positive function h associated with a label-distance function f is h(u, v)=f(u, v) if f(u, v)<=t, and h(u, v)=0 otherwise. False-negative function is similarly defined. For a threshold value t, a false-negative function h associated with a label-distance function f is h (u, v)=f(u, v) if f(u, v)>=t, and h(u, v)=0 otherwise. Metrics, such as confusion matrix, f1, precision, and recall can now be extended based on these functions.

In accordance with one or more embodiments, additional instructions may be tested (Operation 405). Operations 401-406 may be repeated for each instruction to be tested. For example, each instruction to be tested will be combined with a content item to create a prompt, and the prompt will be submitted to the generative model multiple times (15, if using the example above). In an embodiment, the prompt may be altered by changing the instruction without changing the content item. In an embodiment, the prompt may be altered by changing the instruction and the content item.

In accordance with one or more embodiments, once the evaluation has been completed for each instruction, an instruction is selected to be used to generate labels for a set of content items (Operation 406). After testing each instruction and generating an accuracy score associated with each instruction, the most desirable instruction is selected. For example, the instruction resulting in the most accurate predictions may be selected.

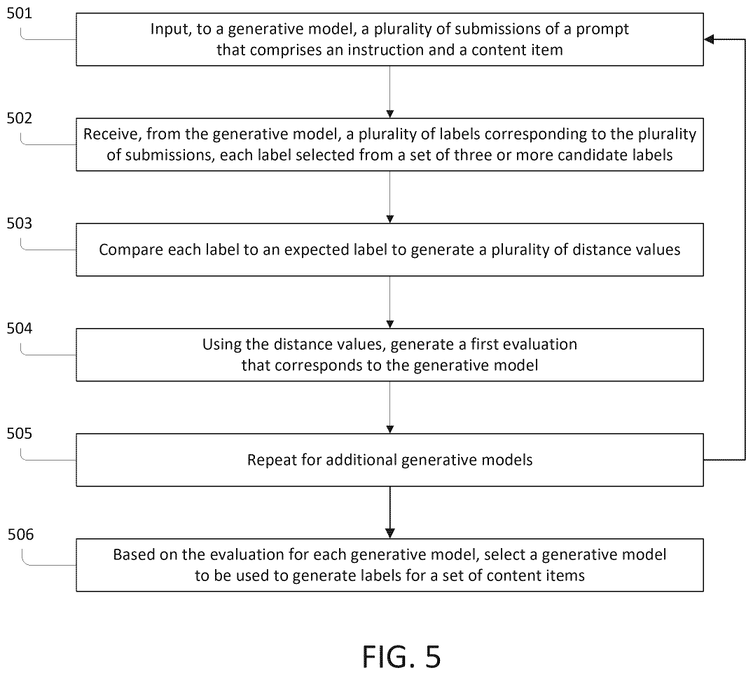

In accordance with one or more embodiments, a similar process may be used to evaluate generative models. FIG. 5 illustrates an example set of operations for selecting a generative model to use for classification tasks in accordance with one or more embodiments. One or more operations illustrated in FIG. 5 may be modified, rearranged, or omitted. Accordingly, the particular sequence of operations illustrated in FIG. 5 should not be construed as limiting the scope of one or more embodiments.

In an embodiment, the system inputs a plurality of submissions of a prompt to a generative model (Operation 501). The prompt comprises an instruction and a content item. commands may also be included in the prompt as previously discussed. Other operations related to generating and submitting prompts are the same as those discussed in connection with FIG. 4. For example, commands to perform a classification task may be implicit.

In accordance with one or more embodiments, the system receives labels corresponding to the submissions (Operation 502). For example, the system may submit a test prompt to a large language model that includes an instruction, a content item, and an explicit or implicit request to perform a classification task. The system then submits the same test prompt additional times. For each submission of the test prompt to the large language model, the system receives a corresponding label that classifies the content item.

In accordance with one or more embodiments, the system compares each label received with an expected label to generate a set of corresponding distance values using the functions previously described in connection with evaluating instructions (Operation 503). As discussed previously, the set of potential label values may be an ordered set of labeled values.

In accordance with one or more embodiments, the system uses the distance values to generate an evaluation that corresponds to the generative model (Operation 504). The evaluation is performed in the same way as the evaluation for prompt labels discussed above except the generative model is altered rather than the template. For example, m generative models may each run a particular prompt k times, repeating the process for each generative model (Operation 505). This results in m*k predictions for each generative model. A label-similarity function g based on these predictions may be used to generate a correctness score. For each prediction u and the corresponding correct label value v, the system can compute the correctness score as g(u, v). The system can then compute the mean of the m*k scores to generate an accuracy score for each model as discussed previously.

In accordance with one or more embodiments, once the evaluation has been completed for each generative model, a generative model is selected to be used to generate labels for a set of content items (Operation 506). After testing each generative model and calculating an accuracy score associated with each generative model, the most desirable generative model is selected. For example, the generative model resulting in the most accurate predictions may be selected.

In accordance with one or more embodiments, the generative model associated with the highest accuracy score, and therefore the most accurate predictions, is not selected. For example, the system may be configured to select the least resource-intensive generative model that meets an accuracy threshold. In another embodiment, the system may be configured to select the least expensive generative model that meets an accuracy threshold. In another embodiment, the system may be configured to select the highest performing (fastest) generative model that meets an accuracy threshold. In an embodiment, any of these factors may be configured to influence the generative model that is selected for further use.

As discussed previously, unlike a statistical model or neural network that will produce the same output if provided the same input, generative models may produce different output even when presented the same prompt multiple times. This presents a problem that is unique to classification problems using generative models. Performing multiple runs of the same prompt on a generative model helps the system generate accuracy scores based on a mean label-distance over the number of runs. More runs of each prompt or on each model results in a more reliable accuracy score. However, compute resources used for generative models are expensive, so it is desirable to select a number of runs that will result in a reliable accuracy score without wasting compute resources. This is particularly helpful in cases where a lot of prompts are expected to be tested.

In accordance with an embodiment, A generative model may run k times on each test content item using the same instruction as discussed above in connection with Operation 404. To select a desirable value for k, test management module 315 uses Welch's T-test to determine a confidence value. In accordance with one or more embodiments, test management module 315 employs adaptive testing strategies, such as sequential testing procedures, to minimize resource consumption while maximizing the likelihood of detecting significant effects, if present.

In accordance with one or more embodiments, a set of runs is performed for each test prompt in a set. For example, a set of 5 test prompts may be selected. Each test prompt is then submitted to a generative model, such as a large language model, a small number of times. The expected output from the generative model for each prompt submission is a label, referred to herein as a test label because it corresponds with a test prompt.

In accordance with one or more embodiments, test management module 315 computes a mean correctness score for each test prompt, using the method described previously herein. Test management module also computes a variance metric for each test prompt. The variance metric measures the variance amongst the sample for each prompt. More specifically, the variance metric is an indication of how much the numbers in the set differ from the average (mean) of the set. The variance may be calculated through a series of steps. First, the system calculates the mean of the set. For each number in the set, the mean is subtracted from that number and then squared. The squared results for the set are then added together. The sum of the squared results is then divided by n−1, where n represents the number of observations in the sample set.

In accordance with one or more embodiments, once the mean correctness score and the variance metric have been calculated, comparison module 325 inputs the mean correctness score and the variance metric to Welch's T-test. Specifically, the values are used as input for the Welch's formulas for the two-sample t-statistic and degrees of freedom. The statistic is then compared to the confidence value from the standard table with a two-tail p value of 0.05. A different two-tail p value may be used in another embodiment. The two-tail p value refers to the probability of observing a test statistic as extreme as, or more extreme than, the value observed in your sample data, under the assumption that the null hypothesis is true. A two-tailed test considers both directions of the effect, meaning it tests for the possibility of a relationship in both directions, e.g., it can detect deviations in both positive and negative directions from the null hypothesis. The “standard table” refers to a t-distribution table. This table provides critical values for the t-distribution at various degrees of freedom and significance levels. The critical value is a point on the scale of the test statistic beyond which the null hypothesis will be rejected. The two-tail p value of 0.05 is a desirable starting point because if the p-value of the test is less than or equal to 0.05, it suggests that the observed data are sufficiently inconsistent with the null hypothesis, so the null hypothesis may be rejected. It corresponds to a 5% risk of concluding that a difference exists when there is no actual difference.

To illustrate the use of Welch's T-test, consider the following example values: mean correctness score of sample 1=0.8; mean correctness score of sample 2=0.594; variance of sample 1=0.08; variance of sample 2=0.05. After trying a few different values for the sample sizes, it may be found that sample sizes of 14, 12 result in a t-statistic of 2.0723 and degrees of freedom of 24. This exceeds the confidence value 2.064, indicating that the two prompts lead to different means with high probability, and the first prompt in this example should be preferred. The total number of runs for the two prompts is 26. In general, 15 runs per prompt are sufficient in most cases to determine the ‘winner’ from a number of prompt variants.

### 6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

In accordance with one or more embodiments, system 300 inputs a prompt (referred to as test prompt A for clarity purposes) into a generative model, such as generative model 340, a plurality of times, receiving a corresponding label each time test prompt A is submitted. Test prompt A is not altered between submissions, resulting in repeated submissions of the same prompt. Test prompt A comprises an instruction and a content item (instruction A and content item A, respectively).

In accordance with an embodiment, each corresponding label is one of a set of three or more candidate labels. For example, the prompt may indicate a set of labels that the generative model is to use to classify content items. Alternatively, the set of labels may be indicated in a configuration file accessible to the generative model.

In accordance with one or more embodiments, the system compares each label for test prompt A to an expected label to compute a distance value for each label from the expected label. The comparison results in the generation of a set of distance values. The system then generates an evaluation based on the distance values. For example, the system may generate a mean correctness score and a variance metric. Once the mean correctness score and the variance metric have been calculated, they can be used as input into Welch's T-test to generate a confidence score. The evaluation is associated with the combination of the instruction used for test prompt A and generative model A 350.

In accordance with one or more embodiments, system 300 inputs an additional prompt (referred to as test prompt B for clarity purposes) into generative model A 340 a plurality of times, receiving a corresponding label whenever a test prompt B is submitted. Each corresponding label is one of the set of three or more candidate labels. In accordance with one or more embodiments, the system compares each label for test prompt B to an expected label to compute a distance value for each label from the expected label. The comparison results in the generation of a set of distance values. Based on the distance values, the system generates an evaluation associated with the combination of the instruction used for test prompt B and generative model A 340.

In accordance with one or more embodiments, system 300 inputs test prompt A into generative model B 350 a plurality of times, receiving a corresponding label whenever test prompt B is submitted. Each corresponding label is one of the set of three or more candidate labels. In accordance with one or more embodiments, the system compares each label for test prompt A to the expected label for test prompt A to compute a distance value for each label from the expected label. The comparison results in the generation of a set of distance values. Based on the distance values, the system generates an evaluation associated with the combination of the instruction used for test prompt A and generative model B 350.

In accordance with one or more embodiments, system 300 inputs a test prompt B into generative model B 350 a plurality of times, receiving a corresponding label each time test prompt B is submitted. Each corresponding label is one of the set of three or more candidate labels. In accordance with one or more embodiments, the system compares each label for test prompt B to the expected label for test prompt B to compute a distance value for each label from the expected label. The comparison results in the generation of a set of distance values. Based on the distance values, the system generates an evaluation associated with the combination of the instruction used for test prompt B and generative model B 350.

In an embodiment, based on the evaluations of the combinations of test prompts and generative models, system 300 selects one of the combinations for use in one or more classification tasks. System 300 may be configured to select the most accurate model/instruction combination. Alternatively, system 300 may be configured to select the model/instruction combination that requires the fewest computational resources while meeting a minimum confidence threshold. For example, system 300 may select the combination of test prompt A and generative model B 350. System 300 may then classify a set of content by submitting each of the content items in the set of content items to generative model B 350 in conjunction with test prompt A. During the classification process, each content item is submitted one time because the selection process is complete. As discussed previously, submission of the content items may be explicit, implicit, or may include commands using one or more characters that imply the content item is to be classified by the first generative model.

### 7. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

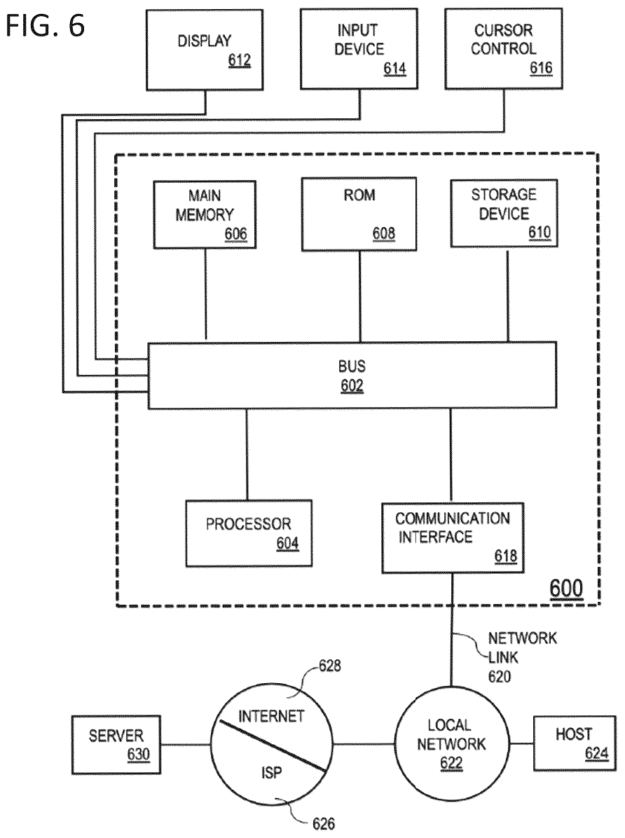

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid-State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
inputting a first plurality of submissions of a same first prompt to a first generative model to generate a corresponding first plurality of labels by the first generative model;
wherein the first prompt comprises: a) a first instruction, and b) a first content item;
wherein each particular label of the first plurality of labels is one of a set of two or more candidate labels;
comparing each particular label of the first plurality of labels to an expected label for the first prompt to compute a distance value for each particular label from the expected label to generate a first plurality of distance values;
generating a first evaluation based at least in part on the first plurality of distance values.

2. The non-transitory media of claim 1, wherein the first evaluation corresponds to the first instruction and wherein the operations further comprise:
inputting a second plurality of submissions of a same second prompt to the first generative model to generate a corresponding second plurality of labels by the first generative model;
wherein the second prompt comprises: a) a second instruction, and b) the first content item;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation of the second instruction based on the second plurality of distance values;
selecting one of the first instruction or the second instruction based at least in part on respective first and second evaluations.

3. The non-transitory media of claim 2, wherein the operations further comprise:
inputting a third plurality of submissions to the first generative model, wherein each of the third plurality of submissions includes: a) the selected instruction, and b) a target content item of a plurality of content items;
receiving a label for each submission of the third plurality of submissions.

4. The non-transitory media of claim 1, wherein the first evaluation corresponds to the first generative model and wherein the operations further comprise:
inputting a second plurality of submissions of the first prompt to a second generative model to generate a corresponding second plurality of labels by the second generative model;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation of the second generative model based on the second plurality of distance values;
selecting one of the first generative model or the second generative model based at least in part on respective first and second evaluations.

5. The non-transitory media of claim 4, wherein the operations further comprise:
inputting a third plurality of submissions to the selected generative model, wherein each of the third plurality of submissions includes: a) the first instruction, and b) a target content item of a plurality of content items;
receiving a label for each submission of the third plurality of submissions.

6. The non-transitory media of claim 1, wherein the first evaluation corresponds to the combination of the first generative model and the first instruction, and wherein the operations further comprise:
inputting a second plurality of submissions of a same second prompt to the first generative model to generate a corresponding second plurality of labels by the first generative model;
wherein the second prompt comprises: a) a second instruction, and b) the first content item;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation based on the second plurality of distance values, wherein the second evaluation corresponds to the combination of the first generative model and the second instruction;
inputting a third plurality of submissions of the first prompt to a second generative model to generate a corresponding third plurality of labels by the second generative model;
comparing each particular label of the third plurality of labels to the expected label for the first prompt to compute a distance value for each particular label from the expected label to generate a third plurality of distance values;
generating a third evaluation based on the third plurality of distance values, wherein the third evaluation corresponds to the combination of the second generative model and the first instruction;
inputting a fourth plurality of submissions of the second prompt to the second generative model to generate a corresponding fourth plurality of labels by the second generative model;
comparing each particular label of the fourth plurality of labels to the expected label for the second prompt to compute a distance value for each particular label from the expected label to generate a fourth plurality of distance values;
generating a fourth evaluation based on the fourth plurality of distance values, wherein the fourth evaluation corresponds to the combination of the second generative model and the second instruction;
based at least in part on respective first, second, third, and fourth evaluations, selecting one of:
a) the combination of the first generative model and the first instruction;
b) the combination of the first generative model and the second instruction;
c) the combination of the second generative model and the first instruction; or
d) the combination of the second generative model and the second instruction.

7. The non-transitory media of claim 6, wherein the operations further comprise:
inputting a fifth plurality of submissions to the selected generative model, wherein each of the fifth plurality of submissions includes: a) the selected instruction, and b) a target content item of a plurality of content items;
receiving a label for each submission of the fifth plurality of submissions.

8. The non-transitory media of claim 1, wherein the operations further comprise:
instructing the first generative model to classify content items using the set of three or more candidate labels by at least one of:
a) submitting a content item;
b) submitting a content item in conjunction with explicit commands to classify the content item; or
c) submitting a content item in conjunction with one or more characters that imply the content item is to be classified by the first generative model.

9. The non-transitory media of claim 1, wherein the first prompt further comprises commands that indicate a requested output format.

10. The non-transitory media of claim 1, wherein a first distance value of the first plurality of distance values is a non-binary distance value.

11. The non-transitory media of claim 1, wherein the first evaluation comprises one or more numeric metrics.

12. The non-transitory media of claim 1, wherein the operations further comprise:
selecting a number of submissions in the plurality of submissions at least by:
performing a set of two or more runs of each test prompt of a plurality of test prompts, wherein a run comprises:
inputting a test prompt to the first generative model to generate a corresponding test label;
based on the set of two or more runs for each test prompt:
computing a mean correctness metric for each test prompt;
computing a variance metric for each test prompt;
based at least in part on the mean correctness metrics and the variance metrics for each test prompt, computing a confidence value;
performing additional runs of each test prompt and re-computing the confidence value until the confidence value meets a predefined threshold;
in response to determining that the confidence value meets the predefined threshold, identifying the number of runs as the number of submissions to be used when inputting the first plurality of submissions.

13. A method, comprising:
inputting a first plurality of submissions of a same first prompt to a first generative model to generate a corresponding first plurality of labels by the first generative model;
wherein the first prompt comprises: a) a first instruction, and b) a first content item;
wherein each particular label of the first plurality of labels is one of a set of three or more candidate labels;
comparing each particular label of the first plurality of labels to an expected label for the first prompt to compute a distance value for each particular label from the expected label to generate a first plurality of distance values;
generating a first evaluation based at least in part on the first plurality of distance values;
wherein the method is performed by at least one device including a hardware processor.

14. The method of claim 13, wherein the first evaluation corresponds to the first instruction, and further comprising:
inputting a second plurality of submissions of a same second prompt to the first generative model to generate a corresponding second plurality of labels by the first generative model;
wherein the second prompt comprises: a) a second instruction, and b) the first content item;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation of the second instruction based on the second plurality of distance values;
selecting one of the first instruction or the second instruction based at least in part on respective first and second evaluations.

15. The method of claim 13, wherein the first evaluation corresponds to the first generative model, and further comprising:
inputting a second plurality of submissions of the first prompt to a second generative model to generate a corresponding second plurality of labels by the second generative model;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation of the second generative model based on the second plurality of distance values;
selecting one of the first generative model or the second generative model based at least in part on respective first and second evaluations.

16. The method of claim 13, wherein the first evaluation corresponds to the combination of the first generative model and the first instruction, and further comprising:
inputting a second plurality of submissions of a same second prompt to the first generative model to generate a corresponding second plurality of labels by the first generative model;
wherein the second prompt comprises: a) a second instruction, and b) the first content item;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation based on the second plurality of distance values, wherein the second evaluation corresponds to the combination of the first generative model and the second instruction;
inputting a third plurality of submissions of the first prompt to a second generative model to generate a corresponding third plurality of labels by the second generative model;
comparing each particular label of the third plurality of labels to the expected label for the first prompt to compute a distance value for each particular label from the expected label to generate a third plurality of distance values;
generating a third evaluation based on the third plurality of distance values, wherein the third evaluation corresponds to the combination of the second generative model and the first instruction;
inputting a fourth plurality of submissions of the second prompt to the second generative model to generate a corresponding fourth plurality of labels by the second generative model;
comparing each particular label of the fourth plurality of labels to the expected label for the second prompt to compute a distance value for each particular label from the expected label to generate a fourth plurality of distance values;
generating a fourth evaluation based on the fourth plurality of distance values, wherein the fourth evaluation corresponds to the combination of the second generative model and the second instruction;
based at least in part on respective first, second, third, and fourth evaluations, selecting one of:
e) the combination of the first generative model and the first instruction;
f) the combination of the first generative model and the second instruction;
g) the combination of the second generative model and the first instruction; or
h) the combination of the second generative model and the second instruction.

17. A system, comprising:
at least one device including a hardware processor;
the system being configured to perform operations comprising:
inputting a first plurality of submissions of a same first prompt to a first generative model to generate a corresponding first plurality of labels by the first generative model;
wherein the first prompt comprises: a) a first instruction, and b) a first content item;
wherein each particular label of the first plurality of labels is one of a set of three or more candidate labels;
comparing each particular label of the first plurality of labels to an expected label for the first prompt to compute a distance value for each particular label from the expected label to generate a first plurality of distance values;
generating a first evaluation based at least in part on the first plurality of distance values.

18. The system of claim 17, wherein the first evaluation corresponds to the first instruction, and wherein the operations further comprise:
inputting a second plurality of submissions of a same second prompt to the first generative model to generate a corresponding second plurality of labels by the first generative model;
wherein the second prompt comprises: a) a second instruction, and b) the first content item;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation of the second instruction based on the second plurality of distance values;
selecting one of the first instruction or the second instruction based at least in part on respective first and second evaluations.

19. The system of claim 17, wherein the first evaluation corresponds to the first generative model, and wherein the operations further comprise:
inputting a second plurality of submissions of the first prompt to a second generative model to generate a corresponding second plurality of labels by the second generative model;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation of the second generative model based on the second plurality of distance values;
selecting one of the first generative model or the second generative model based at least in part on respective first and second evaluations.

20. The system of claim 17, wherein the first evaluation corresponds to the combination of the first generative model and the first instruction, and wherein the operations further comprise:
inputting a second plurality of submissions of a same second prompt to the first generative model to generate a corresponding second plurality of labels by the first generative model;
wherein the second prompt comprises: a) a second instruction, and b) the first content item;
wherein each particular label of the second plurality of labels is one of the set of three or more candidate labels;
comparing each particular label of the second plurality of labels to an expected label for the second prompt to compute a distance value for each particular label from the expected label to generate a second plurality of distance values;
generating a second evaluation based on the second plurality of distance values, wherein the second evaluation corresponds to the combination of the first generative model and the second instruction;
inputting a third plurality of submissions of the first prompt to a second generative model to generate a corresponding third plurality of labels by the second generative model;
comparing each particular label of the third plurality of labels to the expected label for the first prompt to compute a distance value for each particular label from the expected label to generate a third plurality of distance values;
generating a third evaluation based on the third plurality of distance values, wherein the third evaluation corresponds to the combination of the second generative model and the first instruction;
inputting a fourth plurality of submissions of the second prompt to the second generative model to generate a corresponding fourth plurality of labels by the second generative model;
comparing each particular label of the fourth plurality of labels to the expected label for the second prompt to compute a distance value for each particular label from the expected label to generate a fourth plurality of distance values;
generating a fourth evaluation based on the fourth plurality of distance values, wherein the fourth evaluation corresponds to the combination of the second generative model and the second instruction;
based at least in part on respective first, second, third, and fourth evaluations, selecting one of:
i) the combination of the first generative model and the first instruction;
j) the combination of the first generative model and the second instruction;
k) the combination of the second generative model and the first instruction; or
l) the combination of the second generative model and the second instruction.
